(19) United States
(12) Patent Application Publication
(10) Pub. No.: US 2026/0218734 A1
(43) Pub. Date: Jul. 30, 2026

(54) Integrated Electrohydraulic Actuator

(71) Applicant: Parker-Hannifin Corporation, Cleveland, OH (US)

(72) Inventors: Andrea Vacca, Lafayette, IN (US); Hassan Assaf, Lafayette, IN (US); Hao Zhang, Twinsburg, OH (US); Federico Zappaterra, Lafayette, IN (US)

(21) Appl. No.: 19/143,024

(22) PCT Filed: Jan. 18, 2024
(86) PCT No.: PCT/US2024/011917

§ 371 Date: Jun. 25, 2025

Related U.S. Application Data
(60) Provisional application No. 63/493,002, filed on Mar. 30, 2023.

(51) Int. Cl. F15B 15/18; F15B 1/04; F15B 15/14; F15B 21/0423

(52) U.S. Cl. CPC F15B 15/18; F15B 1/04; F15B 15/1485; F15B 21/0423; F15B 2211/20515; F15B 2211/20561; F15B 2211/27; F15B 2211/50518; F15B 2211/7053; F15B 2211/785

(57) ABSTRACT

An example electrohydraulic actuator includes: a housing; a hydraulic cylinder actuator disposed within the housing and comprising a cylinder and a piston, wherein the piston divides an internal space of the cylinder into a first chamber and a second chamber, and wherein the hydraulic cylinder actuator is unbalanced; an accumulator disposed within the housing and comprising an annular fluid chamber encircling the cylinder of the hydraulic cylinder actuator, wherein the accumulator is configured to provide boost fluid flow or receive excess fluid flow comprising a difference between the first fluid flow rate and the second fluid flow rate; and an assembly disposed within the housing and comprising: (i) a pump configured to be a flow source, and (ii) an electric motor configured to drive the pump to provide fluid flow to the first chamber or the second chamber of the hydraulic cylinder actuator to drive the piston.

### CROSS REFERENCE TO RELATED APPLICATION

The present application claims priority to U.S. Provisional Patent Application No. 63/493,002, filed on Mar. 30, 2023, the entire contents of which are herein incorporated by reference as if fully set forth in this description.

### BACKGROUND

A work machine, such as hydraulic excavators, wheel loaders, loading shovels, backhoe shovels, mining equipment, industrial machinery and the like, can have one or more actuated components such as lifting and/or tilting arms, booms, buckets, steering and turning functions, traveling means, etc. Commonly, in such machines, a prime mover drives a hydraulic pump for providing fluid to the actuators. Open-center or closed center valves can control the flow of fluid to the actuators. Such valves are characterized by large power losses due to throttling flow therethrough. Further, such conventional systems may involve providing a constant amount of flow from a pump regardless of how many of the actuators is being used. Thus, such systems are characterized by poor efficiencies.

It may thus be desirable to have a hydraulic system that enhances efficiency of a work machine. With the recent trend toward electrification due to the emission regulations, some hydraulic systems have been configured to include decentralized or distributed electrohydraulic actuators (EHAs) that reduce throttling losses and enables energy recovery from overrunning loads.

An example EHA may include an electrohydraulic power unit having an electric motor driving a pump to provide fluid flow to an actuator such as a linear hydraulic actuator cylinder or hydraulic motor. Typically, standard components are arrangement and connected together to form an EHA. For example, an electric motor is coupled to a pump such that the electric motor is axially spaced from the pump and connected to it via a shaft. The electric motor and pump can be positioned next to a hydraulic cylinder, for example.

Further, a reservoir of fluid may be placed next to the pump. A separate valve block or manifold is also connected to the pump, the reservoir, and the hydraulic cylinder via fluid lines (e.g., pipes, hoses, etc.).

While such arrangement involves the use of standard components, it might not be suitable to many applications such as in construction equipment (e.g., excavators, wheel loaders, etc.), which are subjected to impact, rocks, debris, etc. Particularly, such arrangement might not offer proper structural integrity in an environment where rocks and debris may continually be impacting components of the EHA. Further, such arrangement has a poor power to volume density as it occupies large space. Also, the multiple fluid connections that connect the various components present potential leak points, thus reducing reliability of the system.

As such, it may be desirable to integrate components of the EHA in a self-contained arrangement that is compact with no or minimal external connections to enhance performance and reliability of the EHA. It is with respect to these and other considerations that the disclosure made herein is presented.

### SUMMARY

The present disclosure describes implementations that relate to an integrated electrohydraulic actuator.

Particularly, the present disclosure describes an electrohydraulic actuator wherein an accumulator is integrated with a hydraulic cylinder actuator such that a fluid chamber of the accumulator is formed within a housing of the electrohydraulic actuator and encircles a cylinder of the hydraulic cylinder actuator disposed within the housing.

The present disclosure also describes a method of assembling the electrohydraulic actuator.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a schematic of a hydraulic system, in accordance with an example implementation.

FIG. 2 illustrates a perspective view of an electrohydraulic actuator that integrates an electrohydraulic power unit, an accumulator, valves, and a hydraulic actuator cylinder in an assembly, in accordance with an example implementation.

FIG. 3 illustrates a cross-sectional side view of the electrohydraulic actuator of FIG. 2, in accordance with an example implementation.

FIG. 4 illustrates a perspective cross-sectional view of the electrohydraulic actuator of FIG. 2, in accordance with an example implementation.

FIG. 5 illustrates a perspective view of a first housing portion and an assembly of an electric motor and pump disposed therein, in accordance with an example implementation.

FIG. 6 illustrates a cross-sectional side view of the first housing portion and the assembly disposed therein, in accordance with an example implementation.

FIG. 7 illustrates a perspective partial cross-sectional view of the electrohydraulic actuator of FIG. 2 showing a connector block mounted to a manifold, in accordance with an example implementation.

FIG. 8 illustrates a rear view of the connector block of FIG. 7, in accordance with an example implementation.

FIG. 9 illustrates a perspective partial cross-sectional view of the electrohydraulic actuator of FIG. 2 showing a manifold, in accordance with an example implementation.

FIG. 10 illustrates a rear view of the manifold of FIG. 9, in accordance with an example implementation.

FIG. 11 illustrates a side view of the manifold of FIG. 9, in accordance with an example implementation.

FIG. 12 illustrates a front view of the manifold of FIG. 9, in accordance with an example implementation.

FIG. 13 is a flowchart of a method for assembling the electrohydraulic actuator of FIGS. 2-4, in accordance with an example implementation.

### DETAILED DESCRIPTION

An example hydraulic machine such as an excavator can use multiple hydraulic actuators to accomplish a variety of tasks. Many electric hybrid and battery powered machines use multiple hydraulic cylinders and electric motors to accomplish a variety of tasks. Enhancing efficiency of the machine is desirable, enabling a reduction in hybrid internal combustion engine and/or battery size while reducing the cost of thermal management of the battery.

An example system approach that enhances efficiency comprises an on-demand, closed-circuit system with a dedicated hydrostatic pump and electric motor for each actuator of the machine. This approach can enhance efficiency by eliminating valve metering characterizing conventional systems, pressure overproduction, and standby losses, while enabling hydraulic to electric energy recovery.

The combination of the hydrostatic pump and electric motor can be referred to as an electrohydraulic power unit. As described in more detail below, when such electrohydraulic power unit is used to operate an unbalanced actuator (e.g., a hydraulic cylinder actuator with chambers having different volumes), a variable capacity reservoir (e.g., an accumulator) can be used as a source of fluid to provide boost fluid to the unbalanced actuator. Such reservoir thus makes up for differential fluid flow rates between fluid provided to the actuator and fluid discharged from the actuator. The reservoir may also absorb excess flow when the fluid flow rate discharged from the actuator is larger than the flow rate of fluid provided to the actuator.

Further, various valves can be used to route between the reservoir, the electrohydraulic power unit, and the hydraulic actuator. As such, an electrohydraulic actuator can include a hydraulic cylinder actuator, a reservoir (e.g., accumulator), a valve block or a manifold, and various connections between such components.

Disclosed herein are assemblies involving integrating the various components of an electrohydraulic actuator to enhance power to volume density and reliability of the system. An example the disclosed assembly includes a housing in which a compact electrohydraulic power unit (e.g., electric motor and pump) is disposed. A valve block or manifold integrating various valves of the electrohydraulic actuator is also disposed within the housing. In an example, a connector block is also integrated within the housing to route fluid between the various components of the electrohydraulic actuator. A variable capacity reservoir (e.g., accumulator) is disposed around the hydraulic cylinder, such that the reservoir encircles at least a portion of the cylinder. This configuration may provide a compact, efficient, and reliable assembly.

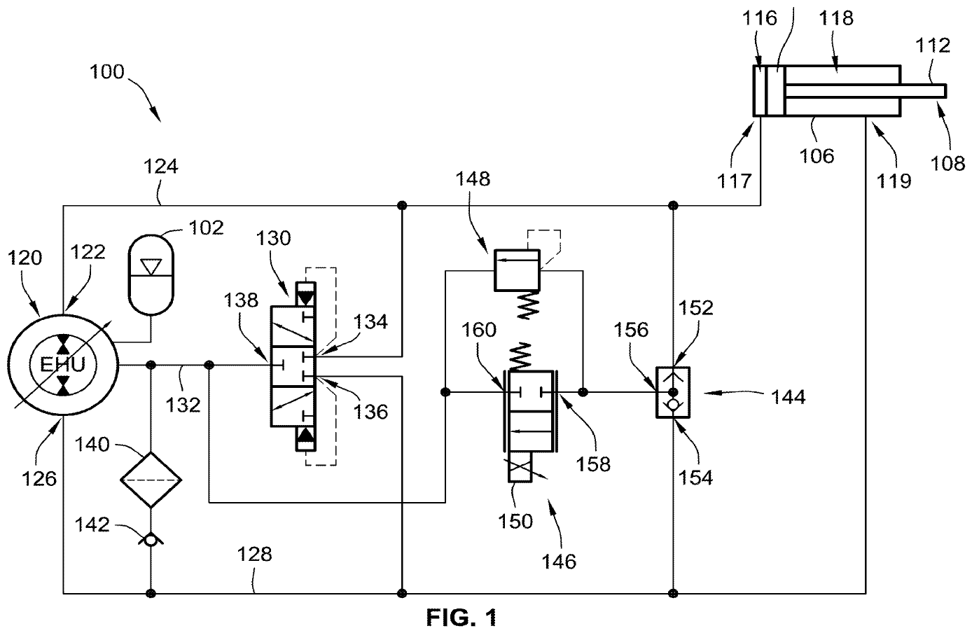

FIG. 1 illustrates a schematic of a hydraulic system 100 using an accumulator 102 as a source of boost fluid flow, in accordance with an example implementation. The hydraulic system 100 includes a hydraulic cylinder actuator 104 having a cylinder 106 and a piston 108 slidably accommodated in the cylinder 106 and configured to move in a linear direction therein.

The piston 108 includes a piston head 110 and a rod 112 extending from the piston head 110 along a central longitudinal axis direction of the cylinder 106. The rod 112 can be coupled to a load that represents, for example, an implement of a machine, e.g., boom, arm, or bucket, and any forces applied thereto. The piston head 110 divides the internal space of the cylinder 106 into a first chamber 116 and a second chamber 118.

The first chamber 116 can be referred to as head-side chamber as the fluid therein interacts with the piston head 110, and the second chamber 118 can be referred to as rod-side chamber as the rod 112 is disposed partially therein. Fluid can flow to and from the first chamber 116 through a workport 117, and can flow to and from the second chamber 118 through a workport 119.

The piston head 110 can have a diameter DH, whereas the rod 112 can have a diameter DR. As such, fluid in the first chamber 116 interacts with a cross-sectional surface area of piston head 110 that can be referred to as piston head area and is equal to

$${A}_{H} = π \frac{{D}_{H}^{2}}{4} .$$

On the other hand, fluid in the second chamber 118 interacts with an annular surface area of the piston 108 that can be referred to as piston annular area

$${A}_{Annular} = π \frac{{D}_{H}^{2} - {D}_{R}^{2}}{4} .$$

The area A_{Annular} is smaller than the piston head area A_{H}. Thus, as the piston 108 extends (e.g., moves to the right in FIG. 1) or retracts (e.g., moves to the left in FIG. 1) within the cylinder 106, the amount of fluid flow Q_{A} going into or being discharged from the first chamber 116 is greater than the amount of fluid flow Qₐ being discharged from or going into the second chamber 118.

Particularly, if the piston 108 is moving at a particular velocity V, then Q_{A}=A_{H}V is greater than Qₐ=A_{Annular}V. The difference in flow can be determined as Q_{A}−Qₐ=A_{R}V, where A_{R} is the cross-sectional area of the rod 112 and is equal to

$$π \frac{{D}_{R}^{2}}{4} .$$

With this configuration, the hydraulic cylinder actuator 104 can be referred to as an unbalanced actuator as fluid flow rate to/from the first chamber 116 is not equal to fluid flow rate to/from the second chamber 118.

The hydraulic system 100 has an electrohydraulic power unit 120 having an electric motor driving a pump. The electrohydraulic power unit 120 is configured to control the rate and direction of hydraulic fluid flow to and from the hydraulic cylinder actuator 104. Such control is achieved by controlling the speed and direction of the electric motor and the pump, which is configured as a bi-directional fluid flow source.

The electrohydraulic power unit 120 has a first pump port 122 connected by a first fluid line 124 to the first chamber 116 of the hydraulic cylinder actuator 104, and has a second pump port 126 connected by a second fluid line 128 to the second chamber 118 of the hydraulic cylinder actuator 104. The term “fluid line” is used throughout herein to indicate one or more fluid passages, conduits or the like that provide the indicated connectivity.

The first pump port 122 and the second pump port 126 are configured to be both inlet and outlet ports based on direction of rotation of a rotor of the electric motor, which drives pump. As the rotor of the electric motor rotates in a first rotational direction, the pump draws fluid from the first pump port 122 (inlet port in this case) and displaces fluid to the second pump port 126 (outlet port in this case). Conversely, as the rotor rotates in a second rotational direction, the pump draws fluid from the second pump port 126 (inlet port in this case) and displaces fluid to the first pump port 122 (outlet port in this case).

Further, as described in more detail below, the electrohydraulic power unit 120 is configured to work in a pumping mode and a motoring mode. In the pumping mode, the electric motor drives the pump to provide fluid to drive the piston 108 against a resistive load.

In the motoring mode (e.g., regenerative mode), the hydraulic cylinder actuator 104 is subjected to an assistive load (e.g., the direction of force acting on the piston 108 is the same as the direction of motion of the piston 108). As such, in the motoring mode, fluid discharged from the hydraulic cylinder actuator 104 and returning to the electrohydraulic power unit 120 drives the pump, which in turn drives the electric motor. In this case, the electric motor operates as an electric generator where fluid energy received at the electrohydraulic power unit 120 is converted to electric power by the electric motor. The electric power generated in this mode can be stored in a battery, for example. As such, the electric motor can generally be referred to as an electric machine configured to operate as an electric motor and an electric generator.

As depicted in FIG. 1, the pump of the electrohydraulic power unit 120 and the hydraulic cylinder actuator 104 are configured in a closed-circuit, i.e., a closed-loop hydraulic circuit. The term “closed-circuit” is used herein to indicate that fluid is being recirculated in a loop between the pump and the hydraulic cylinder actuator 104. Particularly, in the hydraulic system 100, the pump provides fluid through the first pump port 122 to the workport 117 or through the second pump port 126 to the workport 119, and fluid being discharged from the other workport returns to the corresponding port of the pump. As such, fluid is being recirculated between the pump and the hydraulic cylinder actuator 104.

In an example, the pump can be a fixed displacement pump and the amount of fluid flow provided by the pump is controlled by the speed of the electric motor (i.e., by rotational speed of the rotor of the electric motor coupled to the pump). For example, the pump can be configured to have a particular pump displacement PD that determines the amount of fluid generated or provided by the pump in, for example, cubic inches per revolution (in³/rev). The electric motor can be running at a commanded speed having units of revolutions per minute (RPM). As such, multiplying the speed of the electric motor by PD determines the fluid flow rate Q in cubic inches per minute (in³/min) provided by the pump to the hydraulic cylinder actuator 104.

The flow rate Q in turn determines the linear speed of the piston 108. For instance, if the electric motor is driving the pump is a first rotational direction to provide fluid to the first chamber 116, the piston 108 can extend at a speed

$${V}_{1} = \frac{Q}{{A}_{H}} .$$

On the other hand, if the electric motor is driving the pump is a second rotational direction to provide fluid to the second chamber 118, the piston 108 can retract at a speed

$${V}_{2} = \frac{Q}{{A}_{Annular}} .$$

As mentioned above, the hydraulic cylinder actuator 104 is unbalanced such that the amount of fluid flow rate provided to or discharged from the first chamber 116 is greater than the amount of fluid flow rate provided to or discharged from the second chamber 118. As such, the amount of fluid flow rate provided from or received at the first pump port 122 (to or from the first chamber 116) is greater than the amount of fluid flow rate provided from or received at the second pump port 126 (to or from the second chamber 118). Such discrepancy between the fluid flow rate provided by the pump and fluid flow rate received thereat can cause cavitation and the pump might not operate properly.

The hydraulic system 100 includes a variable capacity reservoir such as the accumulator 102 configured to boost the fluid flow rate, or receive any excess flow, to make up for such discrepancy in fluid flow rate. The accumulator 102 may be configured to provide fluid flow at a particular pressure range e.g., between 0 and 15 bar. As a particular example, the accumulator 102 can provide fluid at a pressure level of 4-5 bar.

The accumulator 102 is configured to provide the boost flow or receive the excess flow via a boost flow line 132. In one example, the accumulator 102 can provide or receive fluid directly from the boost flow line 132. In another example, the accumulator 102 provides the boost flow or receives the excess flow to or from the boost flow line 132 via the electrohydraulic power unit 120. Particularly, as described in more detail below, the electric motor and pump of the electrohydraulic power unit 120 can be integrated in an assembly having an internal chamber, and the boost or excess flow flows through such internal chamber to or from the accumulator 102 to cool the electric motor rather than using a separate cooling configuration.

In an example, the accumulator 102 is configured as a pressure storage reservoir in which an incompressible hydraulic fluid is held under pressure that is applied by an external source of mechanical energy. The external source can be an engine, a spring, a raised weight, or compressed gas. For example, the accumulator 102 can have a cylindrical chamber, which has a piston in it. This piston can be spring-loaded or can be pressurized by a gas disposed on one side of the piston.

As fluid is provided into the accumulator 102 (which operates as a sealed container having a fixed volume), fluid volume inside the accumulator 102 increases, and its pressure increases due to the spring or gas pressure acting on the other side of the piston. This way, the accumulator 102 can provide pressurized fluid to the boost flow line 132.

Other types of accumulators can be used. For instance, the accumulator 102 can be a bladder-type accumulator. Such accumulator can include a bladder filled with nitrogen and fitted in a welded or forged steel pressure vessel. The bladder is made of an elastic material (elastomer), e.g., rubber. The gas pre-charge pressure can be adapted via the gas inlet/outlet valve on top of the bladder accumulator. When pressure level of hydraulic fluid within the accumulator decreases, the compressed gas in the bladder expands and pushes the stored fluid into the hydraulic circuit. Conversely, when fluid is provided to the accumulator, it compresses the bladder, thereby increasing pressure level of fluid within the accumulator. In other examples, the accumulator 102 can be a diaphragm accumulator or a spring accumulator where a diaphragm or spring replace compressed gas.

The boost flow line 132 is connected to a reverse shuttle valve 130, which is configured to fluidly couple the chambers 116, 118 of the cylinder 106 to the boost flow line 132 responsive to pressure difference across the pump (i.e., pressure difference between the first fluid line 124 and the second fluid line 128). In an example, the reverse shuttle valve 130 can be configured as a pilot-operated, three-position shuttle valve having a shuttle element therein (e.g., a poppet or spool) the position of which is determined by differential pressure across the pump.

The reverse shuttle valve 130 can have a first pilot port 134 fluidly coupled to the first fluid line 124 and a second pilot port 136 fluidly coupled to the second fluid line 128. The reverse shuttle valve 130 also has a boost port 138 fluidly coupled to the boost flow line 132. The reverse shuttle valve 130 is operated by differential pressure between the fluid lines 124, 128 to either: (i) connect the second fluid line 128 to the boost flow line 132 when pressure in the first fluid line 124 exceeds the pressure level in the second fluid line 128, or (ii) connect the first fluid line 124 to the boost flow line 132 when pressure in the second fluid line 128 exceeds the pressure level in the first fluid line 124.

For example, if the pump is driven by the electric motor to supply fluid to the first fluid line 124 for extension of the piston 108, the pressure differential across the pump shifts the shuttle element of the reverse shuttle valve 130 to connect the boost port 138 to the second pilot port 136, thereby fluidly coupling the second fluid line 128 to the boost flow line 132 while blocking flow from the first fluid line 124 to the boost flow line 132. As such, the reverse shuttle valve 130 provides a fluid flow path from the boost flow line 132 to the second pump port 126 to make up for the difference between flow rate of fluid provided to the first chamber 116 and flow rate of fluid returning through the second fluid line 128 from the second chamber 118.

Conversely, when the pump is driven in the opposite direction to retract the piston 108, the pressure differential across the pump shifts the shuttle element of the reverse shuttle valve 130 to connect the first pilot port 134 to the boost port 138, thereby fluidly coupling the first fluid line 124 to the boost flow line 132 while blocking flow from the second fluid line 128 to the boost flow line 132. This way, the reverse shuttle valve 130 provides a fluid flow path for the excess flow of fluid returning through the first fluid line 124 from the first chamber 116 to the boost flow line 132. Different modes of operation of the hydraulic system 100 and the reverse shuttle valve 130 are described below.

The term “reverse” is ascribed to the reverse shuttle valve 130 as it differs from a traditional shuttle valve. A traditional shuttle valve may have a first inlet, a second inlet, and an outlet. A valve element moves freely within such traditional shuttle valve such that when pressure from fluid is exerted through a particular inlet, it pushes the valve element toward the opposite inlet. This movement may block the opposite inlet, while allowing the fluid to flow from the particular inlet to the outlet. This way, two different fluid sources can provide pressurized fluid to an outlet without back flow from one source to the other. The reverse shuttle valve 130 does not have a designated outlet port, but rather either provides fluid flow from the boost port 138 to the second pilot port 136 or provide fluid flow from the first pilot port 134 to the boost port 138.

In the example configuration described above, the reverse shuttle valve 130 is a pilot-operated valve where the shuttle element moves in response to differential pressure between the fluid lines 124, 128. In other examples, the reverse shuttle valve 130 can be electrically-actuated such that an electronic controller of the hydraulic system 100 can provide electric signals that move the shuttle element based on sensed pressure levels in the fluid lines 124, 128.

In an example, the hydraulic system 100 further includes a filter 140 configured to filter fluid to remove any contaminants in the fluid. In this example, a check valve 142 can be used to prevent back flow from the second fluid line 128 to the filter 140 or the boost flow line 132.

In an example, the hydraulic system further includes a shuttle valve 144, a metering valve 146, and a pressure relief valve 148. The metering valve 146 is configured as a throttling valve that meters or throttles fluid flow discharged from the hydraulic cylinder actuator 104 to achieve low speeds for the piston 108 as described below. For example, the metering valve 146 can be a proportional valve that is electronically actuated via a solenoid 150. An electric command signal from a controller of the hydraulic system 100 to the solenoid 150 controls fluid flow through the metering valve 146.

The shuttle valve 144 has a first inlet port 152 fluidly coupled to the first fluid line 124 and the first chamber 116, and a second inlet port 154 fluidly coupled to the second fluid line 128 and the second chamber 118. The shuttle valve 144 also has an outlet port 156 fluidly coupled to an inlet port 158 of the metering valve 146. An outlet port 160 of the metering valve 146 is fluidly coupled to the boost flow line 132.

When pressure level of fluid in the first chamber 116 is higher than pressure level of fluid in the second chamber 118, the shuttle valve 144 provides a fluid path from the first inlet port 152 (and the first chamber 116) to the outlet port 156. Conversely, when pressure level of fluid in the second chamber 118 is higher than pressure level of fluid in the first chamber 116, the shuttle valve 144 provides a fluid path from the second inlet port 154 (and the second chamber 118) to the outlet port 156

In some cases, the hydraulic cylinder actuator 104 can be subjected to a large force, and such force causes over-pressurization in either of the chambers 116, 118. To protect the hydraulic cylinder actuator 104 from the possibility of over-pressurization, the hydraulic system 100 includes the pressure relief valve 148.

The pressure relief valve 148 is configured to protect the chambers 116, 118. Fluid having the higher pressure level between the chambers 116, 118 flows through the shuttle valve 144 to the pressure relief valve 148. If the pressure level exceeds a threshold value, such as 300 bar or 4350 pounds per square inch (psi), the pressure relief valve 148 opens to relieve such high pressure fluid to the boost flow line 132 when the metering valve 146 is closed (not actuated).

Other types of valves could be added to the hydraulic system 100. For example, load-holding valves could be added. Such load-holding valves could be configured as pilot-operated check valves, counterbalance valves, on/off electronically-controlled valves, etc.

The hydraulic system 100 is configured to operate in at least four modes of operation. A first mode of operation involves extending the piston 108 (e.g., moving the piston 108 to the right in FIG. 1) while the piston 108 is subjected to a resistive load. The term “resistive” indicates that a load applies a force on the piston 108 in a direction that is opposite to the direction of motion of the piston 108. A second mode of operation involves extending the piston 108 while the piston 108 is subjected to an assistive load. The term “assistive” indicates that a load applies a force on the piston 108 that is in the same direction as the direction of motion of the piston 108. This could occur, for example, if the motion of the piston 108 is gravity assisted.

In the first and second modes of operation, the accumulator 102 is configured to provide boost flow through the electric motor to the boost flow line 132. In other words, the accumulator 102 operates in a discharge mode, where fluid is being discharged from the accumulator 102.

A third mode of operation involves retracting the piston 108 (e.g., moving the piston 108 to the left in FIG. 1) while the piston 108 is subjected to a resistive load. A fourth mode of operation involves retracting the piston 108 while the piston 108 is subjected to an assistive load. In the third and fourth modes of operation, the accumulator 102 is configured to receive excess flow from the boost flow line 132 through the electric motor. In other words, the accumulator 102 operates in a charge mode, where excess fluid is used to charge the accumulator 102.

Particularly, to extend the piston 108 while being subjected to a resistive load (the first mode of operation), a controller of the hydraulic system 100 can send a command signal to a power electronics module to operate the electric motor and drive the pump of the electrohydraulic power unit 120 in a first rotational direction. A fluid flow rate Q_{A} is thus provided from the first pump port 122 through the first fluid line 124 to the first chamber 116 to extend the piston 108. As the piston 108 extends, fluid is discharged from the second chamber 118 at a fluid flow rate Qₐ to the second fluid line 128.

At the same time, the accumulator 102 can provide make-up or boost flow Q_{acc} to the boost flow line 132. Particularly, the high pressure fluid in the first fluid line 124 causes the reverse shuttle valve 130 to shift to a state where it fluidly couples the boost flow line 132 to the second fluid line 128. The reverse shuttle valve 130 thus operates in a state where the second pilot port 136 is fluidly coupled to the boost port 138, and therefore the boost flow provided by the accumulator 102 joins fluid discharged from the second chamber 118 in the second fluid line 128. The make-up or boost flow rate Q_{acc} provided by the accumulator 102 is determined as Q_{acc}=A_{R}V, where A_{R} is the cross-sectional area of the rod 112 and Vis the speed of the piston 108 as mentioned above. The combined flow rate Q_{A}=Qₐ+Q_{acc} from the second chamber 118 and the accumulator 102 then flows to the second pump port 126.

As such, the amount of flow rate received at the second pump port 126 is equal to the amount of flow rate provided by the pump through the first pump port 122 and the first fluid line 124 to the first chamber 116. Notably, the fluid returning through the second fluid line 128 to the second pump port 126 from the second chamber 118 has a low pressure level, and therefore, the boost flow Q_{acc} provided by the accumulator 102 can be provided at a low pressure level that matches the low pressure level of flow returning to the second pump port 126. For example, the boost flow can have a pressure level in the range of 0-15 bar compared to high pressure levels such as 300 bar that might be provided by the pump to the first chamber 116 to extend the piston 108 against a resistive load.

In this mode, the electrohydraulic power unit 120 (i.e., the electric motor and the pump) provide hydraulic power P_{EHU} to the hydraulic cylinder actuator 104 to move the piston 108 at a particular speed against a resistive load.

The second mode of operation involves extending the piston 108 while being subjected to an assistive load (extend the piston 108 at a particular speed with an assistive load acting in the same direction). In this mode, fluid in the first fluid line 124 is low pressure fluid, whereas fluid discharged from the second chamber 118 to the second fluid line 128 can be a high pressure fluid. The pump receives fluid flow discharged from the second chamber 118 at the second pump port 126 at a flow rate of Qₐ, and thus provides fluid to the first fluid line 124 at the same flow rate Qₐ. In this case, the high pressure fluid received at the second pump port 126 drives the pump, which in turn drives the electric motor in a regenerative mode, thereby generating power P_{EHU} rather than consuming power.

Also, the high pressure fluid in the second fluid line 128 causes the reverse shuttle valve 130 to shift to a state where it fluidly couples the boost flow line 132 to the first fluid line 124. Particularly, the reverse shuttle valve 130 operates in a state where the first pilot port 134 is fluidly coupled to the boost port 138, and thus the boost flow Q_{acc} provided by the accumulator 102 flows through the boost flow line 132 to the boost port 138, then to the first pilot port 134 to join fluid flow Qₐ provided by the pump in the first fluid line 124. The combined fluid flow Q_{A}=Qₐ+Q_{acc} is provided to the first chamber 116 of the hydraulic cylinder actuator 104.

Notably, the fluid provided by the pump to the first fluid line 124 has a low pressure level. Therefore, the boost flow Q_{acc} provided by the accumulator 102 can be provided at a low pressure level (e.g., between 0 and 15 bar) that matches the low pressure level of flow provided via the first pump port 122.

The third mode of operation involves retracting the piston 108 while being subjected to a resistive load. To retract the piston 108 (e.g., move the piston 108 to the left in FIG. 1), the controller of the hydraulic system 100 can send a command signal to a power electronics module to operate the electric motor and drive the pump in a second rotational direction, opposite the first rotational direction associated with extension of the piston 108. A fluid flow rate Qₐ of high pressure fluid is thus provided from the second pump port 126 through the second fluid line 128 to the second chamber 118 to retract the piston 108. As the piston 108 retracts, fluid is discharged from the first chamber 116 at a fluid flow rate Q_{A} to the first fluid line 124.

As the pump provides fluid flow rate Qₐ at the second pump port 126, it receives the same amount of fluid flow rate at the first pump port 122. The difference in flow (excess flow) between Q_{A} and Qₐ branches to the first pilot port 134 of the reverse shuttle valve 130 and is provided to the accumulator 102 as flow rate Q_{acc} to charge the accumulator 102.

Particularly, the high pressure fluid in the second fluid line 128 causes the reverse shuttle valve 130 to shift to a state where it fluidly couples the boost flow line 132 to the first fluid line 124. Specifically, the reverse shuttle valve 130 operates in a state where the first pilot port 134 is fluidly coupled to the boost port 138, and thus the differential or excess flow Q_{acc}=Q_{A}−Qₐ flows from the first fluid line 124 to the first pilot port 134, then to the boost port 138, to the boost flow line 132, (through the casing or housing of the electric motor and pump) then to the accumulator 102 to charge it. In this mode, the electrohydraulic power unit 120 (i.e., the electric motor and the pump) provide hydraulic power P_{EHU} to the hydraulic cylinder actuator 104 to retract the piston 108 at a particular speed against a resistive load.

The fourth mode of operation involves retracting the piston 108 while being subjected to an assistive load. In this mode of operation, the piston 108 can retract at a particular speed with an assistive load acting in the same direction.

As the piston 108 retracts with assistance from the load, the pump provides low pressure fluid through the second pump port 126 to the second fluid line 128, whereas fluid discharged from the first chamber 116 to the first fluid line 124 can be a high pressure fluid. The pump receives flow discharged from the first chamber 116 at the first pump port 122 at a flow rate Q_{A}, and thus provides fluid to the first fluid line 124 at the same flow rate Q_{A}. In this case, the high pressure fluid received via the first fluid line 124 drives the pump, which in turn drives the electric motor in a regenerative mode, thereby generating power P_{EHU} rather than consuming power.

While the pump provides fluid flow rate Q_{A} to the second fluid line 128, the second chamber 118 receives fluid flow rate Qₐ. The differential or excess flow Q_{A}−Qₐ is provided as accumulator flow Q_{acc} to charge the accumulator 102.

Particularly, the high pressure fluid in the first fluid line 124 causes the reverse shuttle valve 130 to shift to a state where it fluidly couples the boost flow line 132 to the second fluid line 128. Specifically, the reverse shuttle valve 130 operates in a state where the second pilot port 136 is fluidly coupled to the boost port 138, and thus the excess flow Q_{acc}=Q_{A}−Qₐ flows from the second fluid line 128 to the second pilot port 136, to the boost port 138, then to the boost flow line 132, (through the casing or housing of the electric motor and pump) then to the accumulator 102 to charge it.

In the four modes described above, the metering valve 146 might not be used (i.e., the metering valve 146 remains closed in an unactuated state). In some examples, however, it may be desirable to operate the hydraulic cylinder actuator 104 (e.g., extend or retract the piston 108) at low speeds, but the pump and the electric motor may be configured to operate at a minimum speed that might not be suitable for moving the piston 108 at such low speeds. In these cases, the metering valve 146 can be used to throttle fluid to achieve low piston speeds.

For example, if the piston 108 is to be extended against a resistive load at a low speed, the electric motor can be operated at a minimum speed. The metering valve 146 can then be actuated to allow a portion Qₜ of the fluid flowing through the first fluid line 124 to flow through the shuttle valve 144 to the metering valve 146, then to the boost flow line 132 joining the accumulator flow Q_{acc}. By controlling the opening through the metering valve 146 (e.g., via controlling magnitude of voltage or current provided to the solenoid 150 of the metering valve 146), the metering valve 146 can throttle flow to lower the speed to the piston 108 to a desired speed.

To extend the piston 108 with an assistive load, the electric motor may be stopped (i.e., the electric motor and the pump are not commanded to provide flow). The fluid discharged from the second chamber 118 at high pressure flows through the second fluid line 128, and then a portion Qₜ of such flow is provided through the shuttle valve 144 to the metering valve 146, which throttles the flow to control the speed of the piston 108. Fluid flow Qₜ then joins the accumulator flow Q_{acc} and the combined fluid flows through the reverse shuttle valve 130 to the first fluid line 124, then flows to the first chamber 116. This way, no fluid is provided by the pump, and the metering valve 146 controls the speed of the piston 108.

If, however, it is desirable to increase the speed of the piston 108 while being subjected to an assistive load, the electric motor can be operated at its maximum speed to provide a large amount of fluid flow to the first chamber 116 and extend the piston 108 at a high speed.

To retract the piston 108 at a low speed against a resistive load, the electric motor may be operated at a minimum speed. The pump thus provides fluid to the second fluid line 128, and a portion Qₜ of such fluid is provided through the shuttle valve 144, then through the metering valve 146, which throttles flow, then provides fluid to the boost flow line 132. The flow Qₜ joins a portion of the fluid discharged from the first chamber 116, which flows through the reverse shuttle valve 130 to the boost flow line 132, then the combined flow is provided to the accumulator as Q_{acc} to charge the accumulator.

To retract the piston 108 with an assistive load, the electric motor may be stopped (i.e., the electric motor and the pump are not commanded to provide flow). The fluid flow Q_{A} discharged from the first chamber 116 at high pressure, flows through the first fluid line 124, and then through the shuttle valve 144 to the metering valve 146, which throttles the flow to control the speed of the piston 108. In this case, Qₜ=Q_{A} and the fluid flow Qₜ is provided to the boost flow line 132. A portion Q_{acc} of the flow Qₜ is provided to the accumulator 102 as Q_{acc}, whereas another portion Qₐ is provided through the reverse shuttle valve 130 to the second fluid line 128 to be provided to the second chamber 118.

If, however, it is desirable to increase the retraction speed of the piston 108 while being subjected to an assistive load, the electric motor can be operated at its maximum speed to provide a large amount of fluid flow to the second chamber 118 and retract the piston 108 at a high speed.

It may be desirable to integrate components of the hydraulic system 100 into a self-contained electrohydraulic actuator (EHA) unit, where the hydraulic cylinder actuator 104, accumulator 102, the various valves, and the electrohydraulic power unit 120 are integrated into a single unit or assembly to increase the power-to-volume ratio. This configuration may further eliminate the need for couplings and hoses, thereby enhancing reliability of the hydraulic system 100.

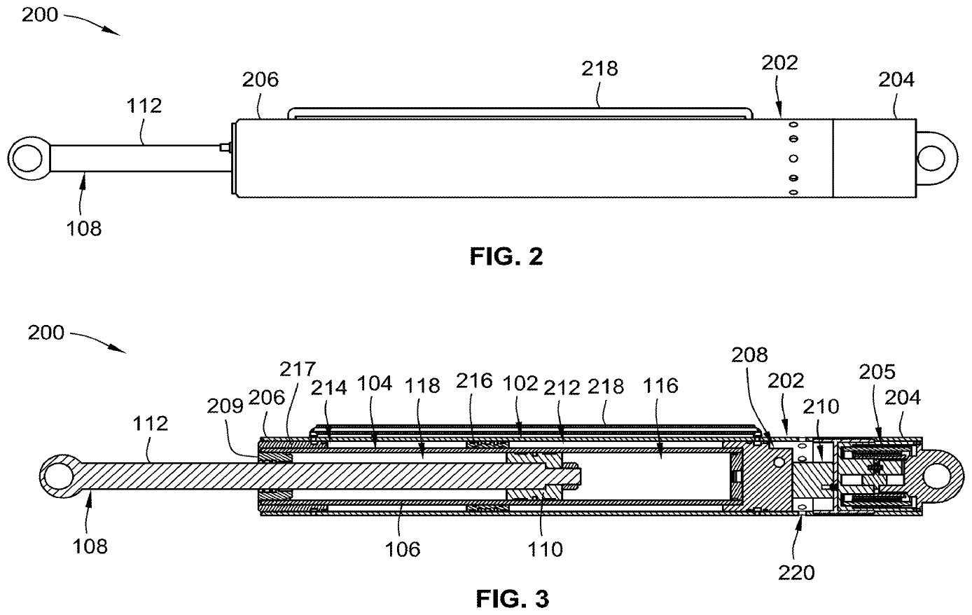

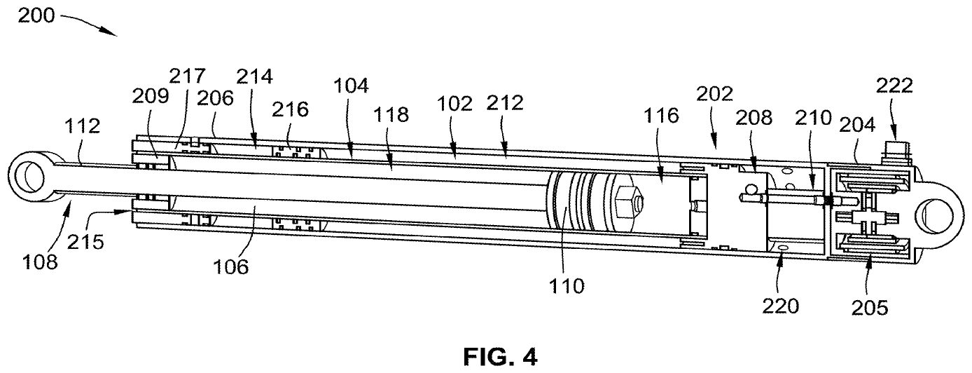

FIG. 2 illustrates a perspective view of an EHA 200 that integrates the electrohydraulic power unit 120, the accumulator 102, the valves, and the hydraulic cylinder actuator 104 of the hydraulic system 100 in an assembly, FIG. 3 illustrates a cross-sectional side view of the EHA 200, and FIG. 4 illustrates a perspective cross-sectional view of the EHA 200, in accordance with an example implementation. FIGS. 2-4 are described together.

The EHA 200 has a housing 202 that includes a first housing portion 204 (e.g., a rear housing cover) and a second housing portion 206 (e.g., a front housing cover) that is coupled to the first housing portion 204. For example, the first housing portion 204 can be threaded into the second housing portion 206. Together, the first housing portion 204 and the second housing portion 206 for the housing 202, which defines an enclosure therein in which the electrohydraulic power unit 120, the valves of the hydraulic system 100, the hydraulic cylinder actuator 104, and the accumulator 102 are disposed.

The first housing portion 204 is configured to house or contain the electrohydraulic power unit 120 including an assembly 205 of an electric motor and pump as described below. The second housing portion 206 is configured to house or contain the hydraulic cylinder actuator 104, the accumulator 102, and a manifold 208 that integrates the valves of the hydraulic system 100.

For example, the hydraulic cylinder actuator 104 can include an end cap or gland 209, and the cylinder 106 of the hydraulic cylinder actuator 104 can be threaded to the gland 209 to mount the hydraulic cylinder actuator 104 within the second housing portion 206. The gland 209 can be generally annular and may have seals mounted on its internal peripheral surface such that the seals are disposed around the rod 112 of the piston 108, thereby sealing the second chamber 118 and preventing fluid leakage to the environment of the EHA 200. The cylinder 106 of the hydraulic cylinder actuator 104 is disposed, at least partially, within the second housing portion 206.

The EHA 200 can also include a connector block 210 that fluidly couples the electrohydraulic power unit 120 to the manifold 208. As shown in FIGS. 3-4, the connector block 210 is partially disposed within the first housing portion 204 and partially disposed within the second housing portion 206, and is interposed between the manifold 208 and the assembly 205.

In the example implementation of FIGS. 2-4, the second housing portion 206 operates as a housing or exterior wall of the accumulator 102. The accumulator 102 has an annular fluid chamber 212 encircling or surrounding the cylinder 106 of the hydraulic cylinder actuator 104, such that the annular fluid chamber 212 is radially interposed or formed between the interior surface of the second housing portion 206 and the exterior surface of the cylinder 106. With this configuration, the hydraulic cylinder actuator 104 is embedded inside the accumulator 102. In other words, the annular fluid chamber 212 is formed between an exterior peripheral surface of the cylinder 106 and an interior peripheral surface of the second housing portion 206.

The annular fluid chamber 212 is configured to contain hydraulic fluid. The volume of size of the annular fluid chamber 212 can be determined and is related to dimensions of the piston 108 (e.g., D_{H}, D_{R}) and the stroke of the piston 108 (distance of travel of the piston 108). The configuration and stroke of the piston 108 determines the volume of boost fluid that would be required to flow to the first chamber 116 or the excess flow discharged therefrom, and thus determines the volume of the annular fluid chamber 212.

In the example implementation of FIGS. 3-4, the accumulator 102 is configured as a piston-type accumulating including an annular gas chamber 214 also encircling or surrounding the cylinder 106 of the hydraulic cylinder actuator 104. The annular gas chamber 214 is configured to include gas (e.g., nitrogen) of the accumulator 102. An accumulator gas valve 215 could be used to pre-charge the annular gas chamber 214 with gas.

The annular gas chamber 214 is separated and sealed from the annular fluid chamber 212 via an annular piston 216 of the accumulator 102. The annular piston 216 encircles or surrounds the cylinder 106 of the hydraulic cylinder actuator 104, and is slidable accommodated in the annular space formed between the second housing portion 206 and the cylinder 106. The annular piston 216 can have one or more seals disposed in annular grooves formed in its exterior surface to seal the annular gas chamber 214 from the annular fluid chamber 212.

As depicted, the annular gas chamber 214 is axially interposed between the annular piston 216 and an accumulator head 217. The accumulator head 217 can have external threads configured to engage with internal threads of the second housing portion 206 to mount the second housing portion 206 to the accumulator head 217.

During charging phase of the accumulator 102, as fluid is provided into the annular fluid chamber 212, the annular piston 216 moves in a distal direction (e.g., to the left in FIG. 3), thereby compressing the gas in the annular gas chamber 214. During the discharge phase, the compressed gas pushes the annular piston 216 in the proximal direction (e.g., to the right in FIG. 3), thereby causing fluid to be discharged from the annular fluid chamber 212 to the manifold 208.

In other examples, a different type of accumulator could be used. For example, rather than the annular piston 216 and the annular gas chamber 214, a bladder or diaphragm may be used to store fluid under pressure in the annular fluid chamber 212 and facilitate discharging fluid therefrom.

As shown in FIGS. 2-3, the EHA 200 can include an external fluid line 218 (e.g., an external pipe) that fluidly couples the manifold 208 to the second chamber 118 of the hydraulic cylinder actuator 104. For example, the external fluid line 218 can couple a port in the manifold 208 (as described below with respect to FIG. 11) to a respective port in the accumulator head 217, and the port of the accumulator head 217 is fluidly coupled via fluid passages in the accumulator head 217 and the cylinder 106 to the second chamber 118. In other example implementations, rather than using the external fluid line 218, channels can be formed internally in the housing 202 (e.g., in the second housing portion 206) to fluidly couple the manifold 208 to the second chamber 118.

In an example, the manifold 208 can include electrohydraulic valves (e.g., the metering valve 146) mounted therein. Such electrohydraulic valves are electrically actuated via solenoids, for example. In some solenoid valves, the solenoid coil is enclosed in a sealed housing that is pressurized or filled with a fluid, such as air or oil. When the solenoid coil is energized, it can generate heat, which can cause the fluid or air inside the solenoid housing to expand. This expansion can create pressure that can affect the operation of the valve and potentially damage the solenoid coil. In this example, to provide air ventilation for the solenoids and prevent these issues, the housing 202 (e.g., the second housing portion 206) can include one or more ventilation holes 220, formed in a circular array around the housing 202. The ventilation holes 220 allow any excess pressure or fluid to escape. This venting ensures that the solenoid coil remains at a safe operating temperature and that the valve operates reliably and consistently. Additionally, venting can also help prevent contamination of the fluid or gas being controlled by the valve by preventing any fluid or gas from entering the solenoid housing.

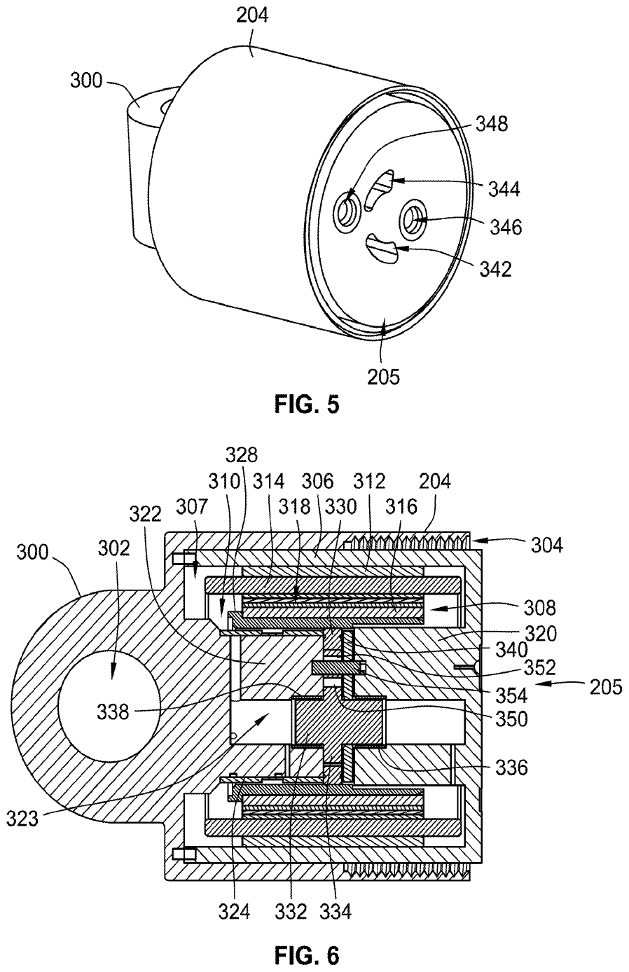

FIG. 5 illustrates a perspective view of the first housing portion 204 and the assembly 205 disposed therein, and FIG. 6 illustrates a cross-sectional side view of the first housing portion 204 and the assembly 205 disposed therein, in accordance with an example implementation. FIGS. 5-6 are described together.

The first housing portion 204 can have a lug mount 300 that has a hole 302. The lug mount 300 is configured as a projection that facilitates mounting the EHA 200 to a frame of a machine, for example, via a fastener disposed through the hole 302. Other mounting configurations, such as a clevis, trunnion mount, flange mount, could be used.

As shown in FIG. 6, the first housing portion 204 can have internal threads 304. The second housing portion 206 can have external threads configured to engage the internal threads 304 to couple the second housing portion 206 to the first housing portion 204.

The assembly 205 is disposed in an internal chamber of the first housing portion 204. The assembly 205 includes a pump-motor casing 306 disposed or received within the first housing portion 204. The first housing portion 204 and the pump-motor casing 306 define an internal chamber 307 in which an electric motor 308 is integrated with a pump 310.

The pump 310 described herein is an internal gear pump as an example for illustration. However, other types of pumps such as a piston pump, a gerotor pump, an external gear pump, or a vane pump, could be used.

The electric motor 308 includes a stator 312 fixedly-positioned within the internal chamber 307 of the pump-motor casing 306. The stator 312 can have wire windings 314 that are wrapped about a body (e.g., a lamination stack) of the stator 312, and when electric current is provided through the wire windings 314, a magnetic field is generated. For example, as shown in FIG. 4, the EHA 200 an include an electric connector 222 mounted to the first housing portion 204 and configured to be connected to a source of electric power (e.g., a battery or electric generator). The electric connector 222 is also electrically coupled to the wire windings 314 to provide electric power thereto.

Referring back to FIG. 6, the electric motor 308 further includes a rotor 316 positioned within the stator 312. The electric motor 308 can further include magnets 318 mounted to the rotor 316 in an annular space between the stator 312 and the rotor 316. The magnets 318 are configured to interact with the magnetic field generated by the wire windings 314 of the stator 312 to rotate the rotor 316 and produce torque. In other example implementation, a different type of electric motor that does not include permanent magnets might be used. Example types of electric motors that could be used include induction motor, surface mounted permanent magnet motor, internal permanent magnet motor, brushless dc motor, wound rotor, and switch reluctance motor.

The pump 310 is mounted, at least partially, within the rotor 316 and the stator 312 of the electric motor 308. The pump 310 has a cylindrical protrusion 320 that is formed as a portion of the pump-motor casing 306 and extends axially or longitudinally within the assembly 205. The pump 310 also includes a cylindrical protrusion 322 that is formed as a portion of the first housing portion 204 and extends axially or longitudinally within the assembly 205 toward the cylindrical protrusion 320 of the pump-motor casing 306.

The cylindrical protrusions 320, 322 face each other and form a space therebetween in which components of the pump 310 are disposed, such that the cylindrical protrusions 320, 322 embrace or sandwich such components of the pump 310. This way, the cylindrical protrusions 320, 322 are configured as a pump housing 323.

The cylindrical protrusion 322 has an annular groove or recess that accommodates an outer bushing 324. The cylindrical protrusion 320 can similarly have an annular groove or recess that accommodates another outer bushing similar to the outer bushing 324.

The assembly 205 includes a drive flange 328 that is generally cylindrical in shape. The drive flange 328 is rotatably coupled to the rotor 316 of the electric motor 308 such that as the rotor 316 rotates, the drive flange 328 rotates therewith. For example, the drive flange 328 can be press fitted inside the rotor 316. Other arrangements, such as key-keyway arrangement, spline arrangement, self-holding taper arrangement, etc. could alternatively be used to couple the rotor 316 to the drive flange 328.

The pump 310 also includes a ring gear 330 that is axially interposed between the cylindrical protrusions 320, 322. The ring gear 330 has internal teeth formed on an interior peripheral surface thereof. In one example, the ring gear 330 is integrated with the drive flange 328 such that the ring gear 330 and the drive flange 328 are formed as one component. In another example, the ring gear 330 can be a separate component that is coupled to the drive flange 328 (e.g., via a key-keyway arrangement, a spline arrangement, a self-holding taper arrangement, etc.).

As depicted in FIG. 6, an outer bushing 324 is interposed radially between an exterior peripheral surface of the cylindrical protrusion 322 and an interior peripheral surface of the drive flange 328. The outer bushing 324 operates as a bearing that support rotation of the drive flange 328 and the ring gear 330 with minimal friction.

The pump 310 has a pump shaft 332 to which a pump pinion 334 (e.g., a spur gear having external teeth formed in an exterior peripheral surface thereof) is mounted to or integrated. The external teeth of the pump pinion 334 engage with the internal teeth of the ring gear 330. Further, the pump pinion 334 is mounted off-center relative to the ring gear 330, i.e., a center of rotation of the pump pinion 334 is eccentric relative to or offset from a respective center of rotation of the ring gear 330.

The cylindrical protrusion 320 has a cavity that accommodates the pump shaft 332, and a first inner bushing 336 is interposed radially between an exterior peripheral surface of the pump shaft 332 and an interior peripheral surface of the cylindrical protrusion 320. Similarly, the cylindrical protrusion 322 has hole or cavity that accommodates the other end of the pump shaft 332, and a second inner bushing 338 is interposed radially between the exterior peripheral surface of the pump shaft 332 and an interior peripheral surface of the cylindrical protrusion 322.

The inner bushings 336, 338 operate as bearings that support rotation of the pump shaft 332 with minimal friction. As the pump shaft 332 is disposed off-center from the ring gear 330, the inner bushings 336, 338 (which support the pump shaft 332) are disposed off-center relative to the outer bushing 324 (which supports the drive flange 328).

The ring gear 330 and the pump pinion 334 are supported axially within via a thrust plate 340 disposed on one side of the ring gear 330 and the pump pinion 334. As such, the pump pinion 334 and the ring gear 330 are interposed or sandwiched between the thrust plate 340 and the cylindrical protrusion 322.

The thrust plate 340 is in turn supported by the cylindrical protrusion 320. Particularly, the thrust plate 340 interfaces with the cylindrical protrusion 320. The thrust plate 340 is configured as a floating component that can move axially to make up for any axial clearances and reduce internal leakage within the pump 310.

As shown in FIG. 5, the pump 310 has a first pump port 342 (e.g., representing the first pump port 122) and a second pump port 344 (e.g., representing the second pump port 126). The pump 310 can be configured to operate as a bi-directional pump. Particularly, the first pump port 342 can operate as an inlet port configured to receive fluid from the hydraulic cylinder actuator 104, and the second pump port 344 can operate as an outlet or discharge port for providing fluid being discharged from the pump 310 to the hydraulic cylinder actuator 104. In this mode of operation, the pump pinion 334 and the ring gear 330 rotate in a first rotational direction and the piston 108 can move in a first direction.

In another mode of operation, the first pump port 342 can operate as a discharge port for providing fluid being discharged from the pump 310 to the hydraulic cylinder actuator 104, and the second pump port 344 can operate as an inlet port configured to receive fluid from the hydraulic cylinder actuator 104. In this mode of operation, the pump pinion 334 and the ring gear 330 rotate in a second rotational direction opposite the first rotational direction, and the piston 108 can move in a second direction opposite the first direction.

Further, the pump 310 can operate in a pumping mode or a motoring mode. In the pumping mode, the pump 310 provides pressurized fluid to the hydraulic cylinder actuator 104 to drive the piston 108 against a resistive load. In the motoring mode, the fluid returning from the hydraulic cylinder actuator 104 is high pressure fluid that can drive the pump 310 and the electric motor 308 in a regenerative mode.

In an example, the assembly 205 can further include a first cooling port 346 and a second cooling port 348. Fluid provided by the accumulator 102 (when the accumulator 102 is in the discharge mode) can flow first through one of the cooling ports 346, 348 to the internal chamber 307 to cool the electric motor 308, then flow through the other cooling port of the cooling ports 346, 348 to the hydraulic cylinder actuator 104.

Similarly, fluid returning to the accumulator 102 from the hydraulic cylinder actuator 104 (when the accumulator 102 is in the charge mode) can flow first through one of the cooling ports 346, 348 to the internal chamber 307 to cool the electric motor 308, then flow through the other cooling port of the cooling ports 346, 348 to the accumulator 102. As described in more detail below, the connector block 210 shown in FIG. 3-4 includes respective ports that correspond to the pump ports 342, 344 and the cooling ports 346, 348 to facilitate directing or routing fluid flow to and from the assembly 205 of the electric motor 308 and the pump 310.

Operation of the pump 310 is described next assuming it rotates in a given direction. However, it should be understood that the pump 310 can operate in the other direction as well where the operation of the ports and fluid volumes is reversed.

During operation, the rotor 316 of the electric motor 308 drives the ring gear 330 via the drive flange 328, causing the ring gear 330 to rotate, which causes the pump pinion 334 to rotate therewith. As mentioned above, the pump pinion 334 rotates off center relative to the ring gear 330. In other words, a longitudinal axis around which the pump pinion 334 rotates is offset from a respective longitudinal axis around which the ring gear 330 rotates.

As the external teeth of the pump pinion 334 and the internal teeth of the ring gear 330 separate or disengage, they create an expanding volume (i.e., expanding chamber). The expanding volume collectively represents multiple pockets formed between the separating teeth. The expanding volume operates as a suction void forming between the separating teeth on the intake side of the pump 310 that is fluidly coupled to the inlet port (e.g., the first pump port 342). Fluid from the inlet port thus fills the expanding volume between the teeth.

Fluid is then carried by the external teeth of the pump pinion 334 and the internal teeth of the ring gear 330 to another chamber or volume on a discharge side of the pump 310, which is fluidly coupled to the outlet port (e.g., the second pump port 344). The meshing of the gear teeth of the pump pinion 334 and the ring gear 330 displaces the fluid, and the fluid is then provided to the outlet port. As such, as the teeth of the pump pinion 334 and the ring gear 330 become interlocked on the discharge side of the pump 310, the volume is reduced and the fluid is forced out under pressure.

As the external teeth of the pump pinion 334 and the internal teeth of the ring gear 330 mesh, they form a seal between the expanding volume having low pressure fluid received from the inlet port and the volume between teeth that are meshing or are about to mesh at the outlet port. The seal created by the meshed teeth forces the fluid out of the discharge port and prevents fluid from flowing back toward the inlet port.

Further, as shown in FIG. 6, the pump 310 includes a crescent seal assembly comprising an inner crescent 350 and an upper or outer crescent 352. The terms “inner” and “outer” indicate radial positioning of the crescents, where the inner crescent 350 is disposed radially inward relative to the outer crescent 352.

The inner crescent 350 and the outer crescent 352 are axially supported within the internal space between the ring gear 330 and the pump pinion 334 by a pivot or locating pin 354. Referring to FIG. 6, the locating pin 354 is disposed partially in blind holes formed in the cylindrical protrusions 320, 322, and extends through a locating pin through-hole in the thrust plate 340 and through the crescents 350, 352.

With this configuration, the inner crescent 350 and the outer crescent 352 are held axially in position by the locating pin 354, and the locating pin 354 also maintains the orientation of the crescents 350, 352. As such, the locating pin 354 supports the crescent seal assembly (the inner crescent 350 and the outer crescent 352) axially.

As the pump pinion 334 and the ring gear 330 rotate during operation of the pump 310, the crescents 350, 352 divide the fluid as it is being carried from the low pressure suction expanding volume to the volume coupled to the discharge port. Thus, the crescents 350, 352 can form a seal between the low pressure volume and the high pressure volume.

Particularly, the outer surface (i.e., radially outward surface) of the outer crescent 352 interfaces with the internal teeth of the ring gear 330 to create a seal therebetween. An effective seal between the outer surface of the outer crescent 352 and the internal teeth of the ring gear 330 may preclude leakage from the high pressure volume to the low pressure volume. The terms “preclude” or “block” fluid flow is used herein to indicate substantially preventing fluid flow except for minimal flow of drops per minute, for example.

In a similar manner, the inner surface (i.e., radially inward surface) of the inner crescent 350 interfaces with the external teeth of the pump pinion 334 to create a seal therebetween. An effective seal between the inner surface of the inner crescent 350 and the external teeth of the pump pinion 334 may preclude leakage from the high pressure volume to the low pressure volume.

As mentioned above, the connector block 210 of the EHA 200 fluidly couples the assembly 205 (the electric motor 308 and the pump 310) to the manifold 208. As such, the connector block 210 is configured to direct fluid between the pump ports 342, 344 (e.g., inlet and outlet ports) of the pump 310 and the manifold 208, and also direct cooling fluid (e.g., fluid provided by or to the accumulator 102) between the assembly 205 and the manifold 208 (which is fluidly coupled to the annular fluid chamber 212 of the accumulator 102).

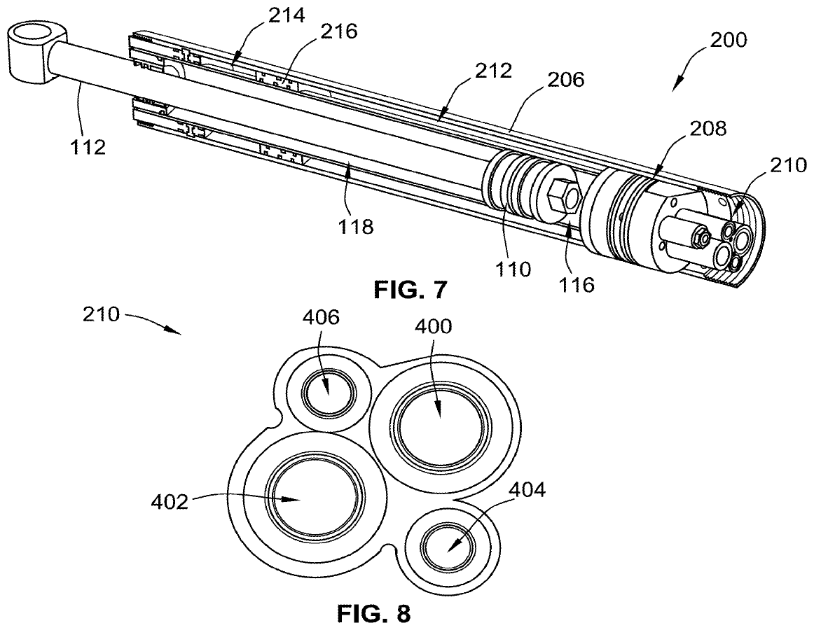

FIG. 7 illustrates a perspective partial cross-sectional view of the EHA 200 showing the connector block 210 mounted to the manifold 208, and FIG. 8 illustrates a rear view of the connector block 210, in accordance with an example implementation. FIG. 7 does not show the assembly 205 to reveal details of the connector block 210. FIG. 8 shows the rear or proximal end of the connector block 210, which interfaces with the assembly 205 disposed within the first housing portion 204.

The connector block 210 includes a first port 400 that is aligned, and is in fluid communication, with the first pump port 342, and includes a second port 402 that is aligned, and is in fluid communication, with the second pump port 344. Further, the connector block 210 can include a first cooling port 404 that is aligned, and is in fluid communication, with the first cooling port 346 of the assembly 205. The first cooling port 404 can fluidly couple the reverse shuttle valve 130 (which is disposed in the manifold 208) to the internal chamber 307 of the assembly 205, for example. Such connection between the reverse shuttle valve 130 and the first cooling port 404 represents the boost flow line 132 described above with respect to FIG. 1, for example.

The connector block 210 can also include a second cooling port 406 that is aligned, and is in fluid communication, with the second cooling port 348 of the assembly 205. The second cooling port 406 can fluidly couple the annular fluid chamber of the accumulator 102 to the internal chamber 307 of the assembly 205, for example.

The manifold 208 integrates the various valves of the hydraulic system 100. The manifold 208 is configured to provide fluid to and receive fluid from the hydraulic cylinder actuator 104 and the accumulator 102, and also provide fluid to and receive fluid from the assembly 205 via the connector block 210.

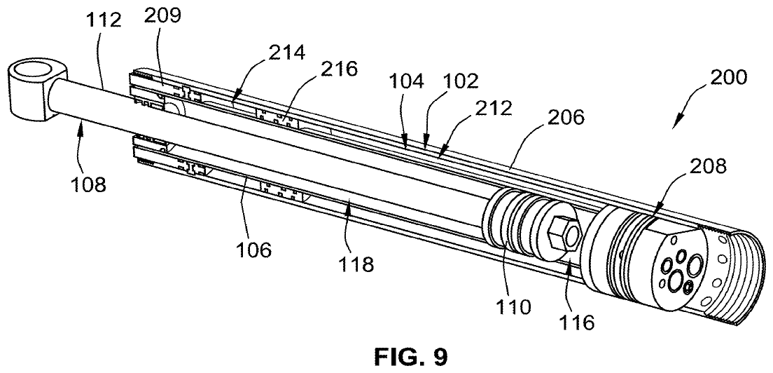

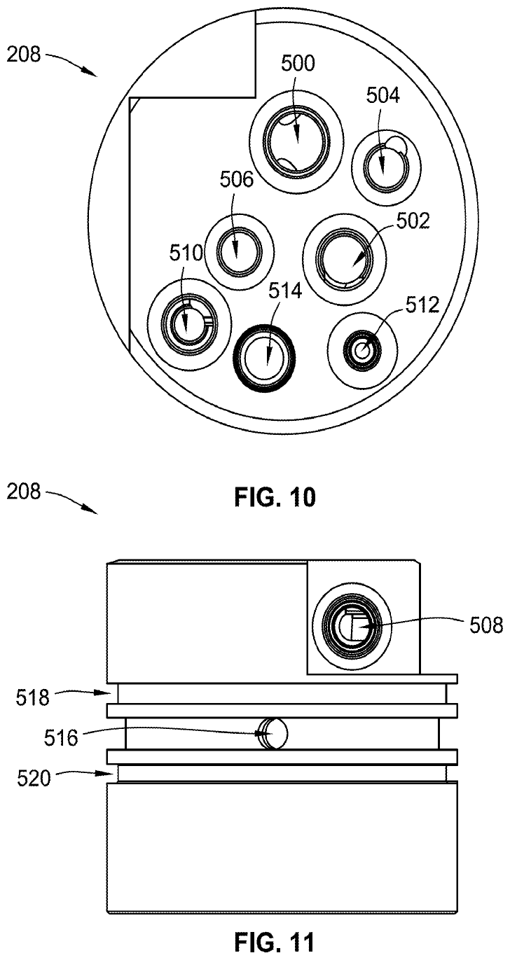

FIG. 9 illustrates a perspective partial cross-sectional view of the EHA 200 showing the manifold 208, FIG. 10 illustrates a rear view of the manifold 208, and FIG. 11 illustrates a side view of the manifold 208, in accordance with an example implementation. FIG. 9 does not show the assembly 205 or the connector block 210 to reveal details of the manifold 208. FIG. 10 shows the rear or proximal end of the connector block 210, which interfaces with the connector block 210. The manifold 208 can have external threads that engage with internal threads in the second housing portion 206 to mount the manifold 208 within the second housing portion 206.

The manifold 208 includes cavities in which the valves of the hydraulic system 100 are mounted, and also includes fluid passages that connect the cavities. The manifold 208 also includes ports and fluid passages that route fluid to and from the hydraulic cylinder actuator 104 and the accumulator 102 on one side of the manifold 208 and the connector block 210 (which is fluidly coupled to the assembly 205) on the other side of the manifold 208.

Referring to FIG. 10, the manifold 208 includes a first manifold port 500 and a second manifold port 502 that are aligned, and in fluid communication, with the ports 400, 402 of the connector block 210 (which are fluidly coupled to the pump ports 342, 344 of the assembly 205). The manifold 208 also includes a first manifold cooling port 504 that can communicate fluid from the accumulator 102 to the internal chamber 307 of the assembly 205 to cool the electric motor 308. The manifold 208 also includes a second manifold cooling port 506 that can communicate fluid that has been communicated from the accumulator 102 to the internal chamber 307, back from the internal chamber 307 to the reverse shuttle valve 130, which is disposed in a cavity 508 shown on the side of the manifold 208 in FIG. 11.

Referring to FIG. 10, the manifold 208 further includes a cavity 510 that receives the pressure relief valve 148 of the hydraulic system 100, and includes cavity 512 that receives the shuttle valve 144 of the hydraulic system 100. The manifold 208 further includes a cavity 514 that receives the metering valve 146 of the hydraulic system 100.

The manifold 208 also receives and provides fluid from and to the chambers 116, 118 of the hydraulic cylinder actuator 104. Referring to FIG. 11, the manifold includes a rod-side chamber port 516 that is fluidly coupled to the second chamber 118 of the hydraulic cylinder actuator 104 via the external fluid line 218 shown in FIGS. 2-3. FIG. 11 also shows that the manifold 208 includes a first annular groove 518 and a second annular groove 520 in which respective seals (e.g., O-rings) can be disposed to seal the manifold 208 against the interior surface of the second housing portion 206.

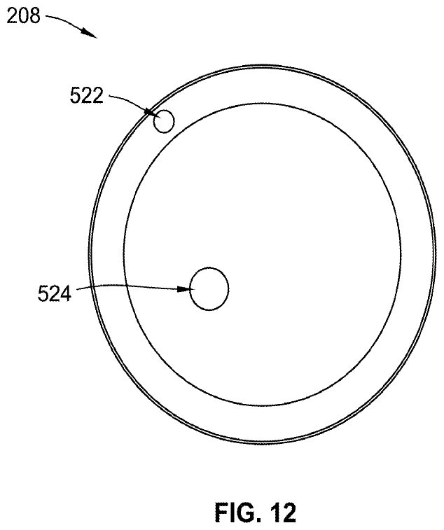

FIG. 12 illustrates a front view of the manifold 208, in accordance with an example implementation. As shown, the manifold 208 includes an accumulator port 522 that is fluidly coupled to the annular fluid chamber 212 of the accumulator 102. With this configuration, the accumulator port 522 can communicate fluid to and from the annular fluid chamber 212 of the accumulator 102. The manifold 208 also includes head-side chamber port 524 that is fluidly coupled to the first chamber 116 of the hydraulic cylinder actuator 104.

As an example of how fluid is routed through the EHA 200, during retraction of the piston 108, fluid is discharged from the first chamber 116, then flows through the head-side chamber port 524 of the manifold 208. A portion of fluid flows through the second manifold port 502, through the second port 402 of the connector block 210 to the second pump port 344.

Another portion of fluid flows to the reverse shuttle valve 130, then through the second manifold cooling port 506, through the second cooling port 406 of the connector block 210, through the second cooling port 348 of the assembly 205 to the internal chamber 307 of the assembly 205 to cool the electric motor 308. Fluid then returns from the internal chamber 307 through the first cooling port 346 of the assembly 205, through the first cooling port 404 of the connector block 210, to the first manifold cooling port 504, through the accumulator port 522, then to the annular fluid chamber 212 of the accumulator 102 to charge the accumulator 102.

Fluid from the first pump port 342 is provided to the first port 400 of the connector block 210, then through the rod-side chamber port 516 of the manifold 208. Fluid is then provided to the second chamber 118 of the hydraulic cylinder actuator 104 via the external fluid line 218 shown in FIGS. 2-3.

This fluid flow routes can be reversed during extension of the piston 108.

The configuration of the EHA 200 may offer several advantages. The accumulator 102 is integrated within the housing 202 of the EHA 200, and encircles the cylinder 106 of the hydraulic cylinder actuator 104. This configuration reduces the overall size and length of the EHA 200 compared to conventional EHAs where the accumulator is a separate element mounted adjacent to the hydraulic cylinder and in communication therewith via fluid lines.

Further, with this configuration of the EHA 200 where the manifold 208, the electrohydraulic power unit 120 (e.g., the assembly 205 of the electric motor 308 and the pump 310), the hydraulic cylinder actuator 104, and the accumulator 102 are integrated in a single housing (e.g., the housing 202), many connections (fluid lines, fittings, couplings, etc.) are eliminated, thereby enhancing reliability of the EHA 200.

Also, as mentioned above, the accumulator 102 provides low pressure fluid, and thus the wall of the second housing portion 206 need not be thickened as it does not need to withstand high pressures. However, by embedding the accumulator 102 within the housing 202, it is protected from debris or collisions that the EHA 200 might be subjected to.

Further, integrating the valves of the EHA 200 in the manifold 208, which is also embedded within the housing 202, protects the valves from debris, shock, or collisions to which the EHA 200 may be subjected.

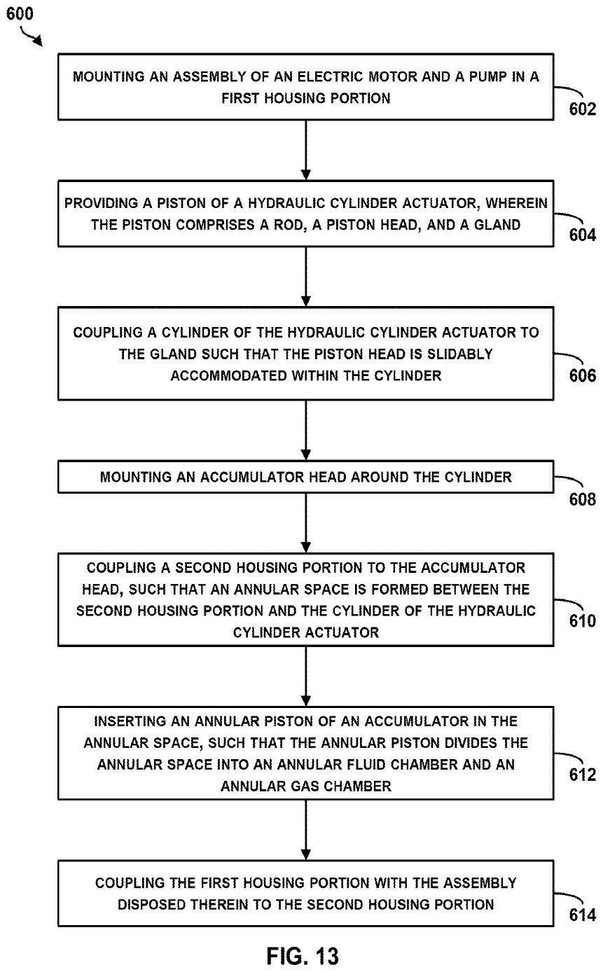

FIG. 13 is a flowchart of a method 600 for assembling the EHA 200 in accordance with an example implementation. The method 600 may include one or more operations, functions, or actions as illustrated by one or more of steps 602-614.

Although the steps are illustrated in a sequential order, these steps may also be performed in parallel, and/or in a different order than those described herein. Also, the various steps may be combined into fewer steps, divided into additional steps, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 602, the method 600 includes mounting the assembly 205 of the electric motor 308 and the pump 310 in the first housing portion 204.

At block 604, the method 600 includes providing the piston 108 of the hydraulic cylinder actuator 104, wherein the piston comprises the rod 112, the piston head 110, and the gland 209. The term “providing” as used herein, and for example with regard to the piston 108 or other components, includes any action to make the piston 108 or any other component available for use, such as bringing the piston 108 or other components to an apparatus or to a work environment for further processing (e.g., mounting other components, etc.).

In example, at the block 604, the method 600 may include providing the rod 112, mounted the gland 209 thereto, then mounting the piston head 110 onto the rod 112, then using a nut to lock the piston head 110 on the rod 112.

At block 606, the method 600 includes coupling the cylinder 106 of the hydraulic cylinder actuator 104 to the gland 209 such that the piston head 110 is slidably accommodated within the cylinder 106. For example, the gland 209 can have external threads, and the cylinder 106 can have corresponding internal threads that allow the cylinder 106 to be screwed onto the gland 209.

At block 608, the method 600 includes mounting the accumulator head 217 around the cylinder 106.

At block 610, the method 600 includes coupling the second housing portion 206 to the accumulator head 217, such that an annular space is formed between the second housing portion 206 and the cylinder 106 of the hydraulic cylinder actuator 104. For example, the accumulator head 217 can include external threads, and the second housing portion 206 can have corresponding internal threads that allow the second housing portion 206 to be screwed onto the accumulator head 217.

At block 612, the method 600 includes inserting the annular piston 216 of the accumulator 102 in the annular space, such that the annular piston 216 divides the annular space into the annular fluid chamber 212 and the annular gas chamber 214.

At block 614, the method 600 includes coupling the first housing portion 204 with the assembly 205 disposed therein to the second housing portion 206. For example, the first housing portion 204 can have internal threads 304, and the second housing portion 206 can have external threads configured to engage the internal threads 304 to couple the second housing portion 206 to the first housing portion 204.

The method 600 can further include other steps to assemble the EHA 200 as described throughout herein.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiment (EEEs) listed below.

EEE 1 is an electrohydraulic actuator comprising: a housing; a hydraulic cylinder actuator disposed within the housing and comprising a cylinder and a piston, wherein the piston divides an internal space of the cylinder into a first chamber and a second chamber, and wherein the hydraulic cylinder actuator is unbalanced such that a first fluid flow rate of fluid provided to the first chamber or the second chamber to drive the piston in a given direction is different from a second fluid flow rate of fluid discharged from the other chamber as the piston moves; an accumulator disposed within the housing and comprising an annular fluid chamber encircling the cylinder of the hydraulic cylinder actuator, wherein the accumulator is configured to provide boost fluid flow from the annular fluid chamber or receive excess fluid flow at the annular fluid chamber, wherein the boost fluid flow or excess fluid flow comprises a difference between the first fluid flow rate and the second fluid flow rate; and an assembly disposed within the housing and comprising: (i) a pump configured to be a bi-directional fluid flow source, and (ii) an electric motor configured to drive the pump in opposite rotational directions to provide fluid flow to the first chamber or the second chamber of the hydraulic cylinder actuator to drive the piston.

EEE 2 is the electrohydraulic actuator of EEE 1, wherein the accumulator further comprises: an annular piston disposed around the cylinder of the hydraulic cylinder actuator, wherein the annular piston is slidably accommodated in an annular space formed between the housing and the cylinder of the hydraulic cylinder actuator; and an annular gas chamber encircling the cylinder, wherein the annular piston separates the annular fluid chamber from the annular gas chamber.

EEE 3 is the electrohydraulic actuator of any of EEEs 1-2, wherein the assembly comprises an internal chamber in which the electric motor and the pump are disposed, wherein the boost fluid flow provided from the annular fluid chamber of the accumulator flows through the internal chamber to cool the electric motor prior to flowing to the hydraulic cylinder actuator, and wherein the excess fluid flow from the hydraulic cylinder actuator flows through the internal chamber to cool the electric motor prior to flowing to the annular fluid chamber of the accumulator.

EEE 4 is the electrohydraulic actuator of any of EEEs 1-3, wherein the accumulator further comprises an accumulator head having external threads, wherein the housing comprises internal threads engaging the external threads of the accumulator head to mount the housing to the accumulator head.

EEE 5 is the electrohydraulic actuator of any of EEEs 1-4, wherein the housing comprises: a first housing portion in which the assembly of the electric motor and the pump is disposed; and a second housing portion coupled to the first housing portion, wherein the second housing portion comprises the accumulator and the hydraulic cylinder actuator, such that the cylinder of the hydraulic cylinder actuator is disposed within the second housing portion, and the accumulator is disposed in an annular space between the cylinder and the second housing portion.

EEE 6 is the electrohydraulic actuator of any of EEEs 1-5, wherein the electric motor comprises (i) a stator that is fixedly positioned in the housing, and (ii) a rotor positioned within the stator and rotatable relative to the stator, and wherein the pump is a gear pump positioned, at least partially, within the rotor of the electric motor, wherein the gear pump comprises: (i) a drive flange rotatably coupled to the rotor of the electric motor, (ii) a ring gear coupled to the drive flange and configured to rotate therewith, (iii) a pump pinion disposed within the ring gear, such that external teeth of the pump pinion engage with internal teeth of the ring gear, and (iv) a plurality of ports comprising: a first pump port and a second pump port, wherein as the rotor rotates, the drive flange and the ring gear rotate therewith, causing the pump pinion to rotate within the ring gear, such that fluid is drawn through the first pump port and displaced to the second pump port for discharge.

EEE 7 is the electrohydraulic actuator of EEE 6, further comprising: a pump-motor casing comprising a first cylindrical protrusion, wherein the housing comprises a second cylindrical protrusion facing the first cylindrical protrusion, such that the ring gear and the pump pinion are interposed between the first cylindrical protrusion and the second cylindrical protrusion.

EEE 8 is the electrohydraulic actuator of any of EEEs 1-7, further comprising: a manifold disposed within the housing and fluidly coupled to the pump, the accumulator, and the hydraulic cylinder actuator, wherein the manifold comprises a plurality of ports, cavities configured to receive respective valves therein, and fluid passages.

EEE 9 is the electrohydraulic actuator of EEE 8, wherein the manifold comprises: a head-side chamber port that is fluidly coupled to the first chamber of the hydraulic cylinder actuator; and a rod-side chamber port that is fluidly coupled to the second chamber of the hydraulic cylinder actuator.

EEE 10 is the electrohydraulic actuator of EEE 9, wherein the rod-side chamber port is fluidly coupled to the second chamber via an external fluid line disposed outside the housing.

EEE 11 is the electrohydraulic actuator of any of EEEs 8-10, wherein the manifold comprises: an accumulator port that is fluidly coupled to the annular fluid chamber of the accumulator.

EEE 12 is the electrohydraulic actuator of any of EEEs 8-11, wherein the pump comprises a first pump port and a second pump port, wherein the pump is configured to draw fluid through the first pump port and displace the fluid to the second pump port for discharge, wherein the manifold further comprises: a first manifold port that is fluidly coupled to the first pump port; and a second manifold port that is fluidly coupled to the second pump port.

EEE 13 is the electrohydraulic actuator of EEE 12, wherein the assembly comprises a first cooling port and a second cooling port that are in fluid communication with an internal chamber of the assembly in which the electric motor is disposed, wherein the manifold comprises: a first manifold cooling port that is fluidly coupled to the first cooling port of the assembly; and a second manifold cooling port that is fluidly coupled to the second cooling port of the assembly, wherein the boost fluid flow provided from the annular fluid chamber of the accumulator flows through the first manifold cooling port to the first cooling port of the assembly, then through the internal chamber to cool the electric motor prior to being discharged from the internal chamber through the second cooling port of the assembly to the second manifold cooling port.

EEE 14 is the electrohydraulic actuator of EEE 13, further comprising: a connector block interposed between the manifold and the assembly, wherein the connector block is configured to fluidly couple the assembly to the manifold.

EEE 15 is the electrohydraulic actuator of EEE 14, wherein the connector block comprises: a first port that is fluidly coupled to the first pump port and the first manifold port; a second port that is fluidly coupled to the second pump port and the second manifold port; a first cooling port that is fluidly coupled to the first cooling port of the assembly and the first manifold cooling port; and a second cooling port that is fluidly coupled to the second cooling port of the assembly and the second manifold cooling port.

EEE 16 is the electrohydraulic actuator of any of EEEs 8-15, wherein the manifold comprises at least one valve that is electronically actuated via a solenoid, wherein the housing comprises one or more ventilation holes, allowing expanding air resulting from operation of the solenoid to be vented to an environment of the housing.

EEE 17 is the electrohydraulic actuator of any of EEEs 8-16, wherein the manifold comprises: at least one annular groove in which a seal is disposed to seal the manifold against an interior surface of the housing.

EEE 18 is a method for assembling the electrohydraulic actuator of any of EEEs 1-17. The method comprises: mounting an assembly of an electric motor and a pump in a first housing portion; providing a piston of a hydraulic cylinder actuator, wherein the piston comprises a rod, a piston head, and a gland; coupling a cylinder of the hydraulic cylinder actuator to the gland such that the piston head is slidably accommodated within the cylinder; mounting an accumulator head around the cylinder; coupling a second housing portion to the accumulator head, such that an annular space is formed between the second housing portion and the cylinder of the hydraulic cylinder actuator; inserting an annular piston of an accumulator in the annular space, such that the annular piston divides the annular space into an annular fluid chamber and an annular gas chamber; and coupling the first housing portion with the assembly disposed therein to the second housing portion.

EEE 19 is the method of EEE 18, further comprising: mounting a manifold to the second housing portion to be fluidly coupled to the annular fluid chamber of the accumulator and the hydraulic cylinder actuator; and mounting a connector block to the manifold prior to coupling the first housing portion to the second housing portion.

EEE 20 is the method of EEE 19, wherein the piston head divides an internal space of the cylinder into a first chamber and a second, and wherein the method further comprises: mounting an external pipe to the second housing portion to fluidly couple the second chamber to the manifold.

What is claimed is:

1. An electrohydraulic actuator comprising:
a housing;
a hydraulic cylinder actuator disposed within the housing and comprising a cylinder and a piston, wherein the piston divides an internal space of the cylinder into a first chamber and a second chamber, and wherein the hydraulic cylinder actuator is unbalanced such that a first fluid flow rate of fluid provided to the first chamber or the second chamber to drive the piston in a given direction is different from a second fluid flow rate of fluid discharged from the other chamber as the piston moves;
an accumulator disposed within the housing and comprising an annular fluid chamber encircling the cylinder of the hydraulic cylinder actuator, wherein the accumulator is configured to provide boost fluid flow from the annular fluid chamber or receive excess fluid flow at the annular fluid chamber, wherein the boost fluid flow or excess fluid flow comprises a difference between the first fluid flow rate and the second fluid flow rate; and
an assembly disposed within the housing and comprising: (i) a pump configured to be a bi-directional fluid flow source, and (ii) an electric motor configured to drive the pump in opposite rotational directions to provide fluid flow to the first chamber or the second chamber of the hydraulic cylinder actuator to drive the piston.

2. The electrohydraulic actuator of claim 1, wherein the accumulator further comprises:
an annular piston disposed around the cylinder of the hydraulic cylinder actuator, wherein the annular piston is slidably accommodated in an annular space formed between the housing and the cylinder of the hydraulic cylinder actuator; and
an annular gas chamber encircling the cylinder, wherein the annular piston separates the annular fluid chamber from the annular gas chamber.

3. The electrohydraulic actuator of claim 1, wherein the assembly comprises an internal chamber in which the electric motor and the pump are disposed, wherein the boost fluid flow provided from the annular fluid chamber of the accumulator flows through the internal chamber to cool the electric motor prior to flowing to the hydraulic cylinder actuator, and wherein the excess fluid flow from the hydraulic cylinder actuator flows through the internal chamber to cool the electric motor prior to flowing to the annular fluid chamber of the accumulator.

4. The electrohydraulic actuator of claim 1, wherein the accumulator further comprises an accumulator head having external threads, wherein the housing comprises internal threads engaging the external threads of the accumulator head to mount the housing to the accumulator head.

5. The electrohydraulic actuator of claim 1, wherein the housing comprises:
a first housing portion in which the assembly of the electric motor and the pump is disposed; and
a second housing portion coupled to the first housing portion, wherein the second housing portion comprises the accumulator and the hydraulic cylinder actuator, such that the cylinder of the hydraulic cylinder actuator is disposed within the second housing portion, and the accumulator is disposed in an annular space between the cylinder and the second housing portion.

6. The electrohydraulic actuator of claim 1, wherein the electric motor comprises (i) a stator that is fixedly positioned in the housing, and (ii) a rotor positioned within the stator and rotatable relative to the stator, and wherein the pump is a gear pump positioned, at least partially, within the rotor of the electric motor, wherein the gear pump comprises: (i) a drive flange rotatably coupled to the rotor of the electric motor, (ii) a ring gear coupled to the drive flange and configured to rotate therewith, (iii) a pump pinion disposed within the ring gear, such that external teeth of the pump pinion engage with internal teeth of the ring gear, and (iv) a plurality of ports comprising: a first pump port and a second pump port, wherein as the rotor rotates, the drive flange and the ring gear rotate therewith, causing the pump pinion to rotate within the ring gear, such that fluid is drawn through the first pump port and displaced to the second pump port for discharge.

7. The electrohydraulic actuator of claim 6, further comprising:
a pump-motor casing comprising a first cylindrical protrusion, wherein the housing comprises a second cylindrical protrusion facing the first cylindrical protrusion, such that the ring gear and the pump pinion are interposed between the first cylindrical protrusion and the second cylindrical protrusion.

8. The electrohydraulic actuator of claim 1, further comprising:
a manifold disposed within the housing and fluidly coupled to the pump, the accumulator, and the hydraulic cylinder actuator, wherein the manifold comprises a plurality of ports, cavities configured to receive respective valves therein, and fluid passages.

9. The electrohydraulic actuator of claim 8, wherein the manifold comprises:
a head-side chamber port that is fluidly coupled to the first chamber of the hydraulic cylinder actuator; and
a rod-side chamber port that is fluidly coupled to the second chamber of the hydraulic cylinder actuator.

10. The electrohydraulic actuator of claim 9, wherein the rod-side chamber port is fluidly coupled to the second chamber via an external fluid line disposed outside the housing.

11. The electrohydraulic actuator of claim 8, wherein the manifold comprises:
an accumulator port that is fluidly coupled to the annular fluid chamber of the accumulator.

12. The electrohydraulic actuator of claim 8, wherein the pump comprises a first pump port and a second pump port, wherein the pump is configured to draw fluid through the first pump port and displace the fluid to the second pump port for discharge, wherein the manifold further comprises:
a first manifold port that is fluidly coupled to the first pump port; and
a second manifold port that is fluidly coupled to the second pump port.

13. The electrohydraulic actuator of claim 12, wherein the assembly comprises a first cooling port and a second cooling port that are in fluid communication with an internal chamber of the assembly in which the electric motor is disposed, wherein the manifold comprises:
a first manifold cooling port that is fluidly coupled to the first cooling port of the assembly; and
a second manifold cooling port that is fluidly coupled to the second cooling port of the assembly, wherein the boost fluid flow provided from the annular fluid chamber of the accumulator flows through the first manifold cooling port to the first cooling port of the assembly, then through the internal chamber to cool the electric motor prior to being discharged from the internal chamber through the second cooling port of the assembly to the second manifold cooling port.

14. The electrohydraulic actuator of claim 13, further comprising:
a connector block interposed between the manifold and the assembly, wherein the connector block is configured to fluidly couple the assembly to the manifold.

15. The electrohydraulic actuator of claim 14, wherein the connector block comprises:
a first port that is fluidly coupled to the first pump port and the first manifold port;
a second port that is fluidly coupled to the second pump port and the second manifold port;
a first cooling port that is fluidly coupled to the first cooling port of the assembly and the first manifold cooling port; and
a second cooling port that is fluidly coupled to the second cooling port of the assembly and the second manifold cooling port.

16. The electrohydraulic actuator of claim 8, wherein the manifold comprises at least one valve that is electronically actuated via a solenoid, wherein the housing comprises one or more ventilation holes, allowing expanding air resulting from operation of the solenoid to be vented to an environment of the housing.

17. The electrohydraulic actuator of claim 8, wherein the manifold comprises:
at least one annular groove in which a seal is disposed to seal the manifold against an interior surface of the housing.

18. A method for assembling an electrohydraulic actuator, the method comprising:
mounting an assembly of an electric motor and a pump in a first housing portion;
providing a piston of a hydraulic cylinder actuator, wherein the piston comprises a rod, a piston head, and a gland;
coupling a cylinder of the hydraulic cylinder actuator to the gland such that the piston head is slidably accommodated within the cylinder;
mounting an accumulator head around the cylinder;
coupling a second housing portion to the accumulator head, such that an annular space is formed between the second housing portion and the cylinder of the hydraulic cylinder actuator;
inserting an annular piston of an accumulator in the annular space, such that the annular piston divides the annular space into an annular fluid chamber and an annular gas chamber; and
coupling the first housing portion with the assembly disposed therein to the second housing portion.

19. The method of claim 18, further comprising:
mounting a manifold to the second housing portion to be fluidly coupled to the annular fluid chamber of the accumulator and the hydraulic cylinder actuator; and
mounting a connector block to the manifold prior to coupling the first housing portion to the second housing portion.

20. The method of claim 19, wherein the piston head divides an internal space of the cylinder into a first chamber and a second, and wherein the method further comprises:
mounting an external pipe to the second housing portion to fluidly couple the second chamber to the manifold.
